(19) United States
(12) Patent Application Publication
(10) Pub. No.: US 2020/0057546 A1
(43) Pub. Date: Feb. 20, 2020

(54) USER INTERFACE AND METHODS FOR INPUTTING AND OUTPUTTING INFORMATION IN A VEHICLE

(71) Applicant: VISTEON GLOBAL TECHNOLOGIES, INC., Van Buren Township, MI (US)

(72) Inventors: Yanning Zhao, Monheim (DE); Elie Abi-Chaaya, Jouy le Moutier (FR)

(73) Assignee: VISTEON GLOBAL TECHNOLOGIES, INC., Van Buren Township, MI (US)

(21) Appl. No.: 16/347,494

(22) PCT Filed: Nov. 3, 2017
(86) PCT No.: PCT/EP2017/078136

§ 371 Date: May 3, 2019

(30) Foreign Application Priority Data
Nov. 3, 2016 (DE) 102016120995.3

(51) Int. Cl. G06F 3/0481; G06F 3/01; G06F 3/03; B60K 37/06; B60K 35/00

(52) U.S. Cl. CPC G06F 3/04815; G06F 3/013; G06F 3/0304; G06F 3/0482; B60K 37/06; B60K 35/00; G06F 3/017

(57) ABSTRACT

A user interface and method for inputting and outputting information in a vehicle provides a user interface with a three-dimensional operating element. A laser projection unit generates at least one virtual three-dimensional operating element. A means for gesture recognition as a means for detection of an input are arranged in the interior of a vehicle. At least one virtual three-dimensional operating element is projected in the visual range of a driver by means of a laser projection arrangement. A gesture of the driver is detected by a gesture recognition means. A position of a hand of the driver is detected by means of the gesture recognition that coincides with an area of the virtual operating element. A signal for controlling a vehicle system or a function of a vehicle system is generated by the central control and evaluation unit and is output to the corresponding vehicle system.

### CROSS REFERENCE TO RELATED APPLICATIONS

This application claims the benefit of PCT Patent Application No. PCT/EP2017/078136 filed on Nov. 3, 2017, entitled “USER INTERFACE AND METHODS FOR INPUTTING AND OUTPUTTING INFORMATION IN A VEHICLE,” which is incorporated by reference in its entirety in this disclosure.

### TECHNICAL FIELD

The invention relates to a user interface which comprises an arrangement for the generation of images, the displaying of images and information and a means for detecting a gesture of a user, wherein the arrangement for the generation of images and the means for detecting a gesture are connected to a central control unit.

The invention relates to a user interface which comprises an arrangement for image generation and for representing images and information, and a means for the detection of an input, wherein the arrangement and the means are connected to a central control and evaluation unit.

The invention also relates to a method for inputting and outputting information in a vehicle, in which information is output by means of an arrangement for image generation and in which inputs of a driver are detected by a means for detecting an input, wherein a control of the output of the information and the detection of an input is controlled by a central control unit.

The invention describes options for controlling a machine, for example a vehicle, by means of instructions of a user or driver via a user interface. In this context, a vehicle can be any technical device for moving, preferably motorized land, air or water vehicles, such as a motor vehicle, truck, rail vehicle, airplane or a boat.

### BACKGROUND

A so-called user interface, also called operator interface or English “Human Machine Interface” (HMI), defines the way how a human can communicate with a machine, and vice versa. The user interface determines how the human passes on its instructions to the machine, how the machine reacts to the user inputs and in what form the machine is providing its response. Such user interface must be adapted to the needs and abilities of a human and are usually ergonomically designed.

Modern motor vehicles generally have a plurality of user interfaces. This includes means for inputting instructions or commands, such as pedals, a steering wheel, gearshift levers and indicator levers, switches, keys or input elements or control elements implemented on a display surface. This also includes suitable means for the optical, acoustic or haptic perception or response, such as displays for speed, range, drive settings or transmission settings, radio programs, sound settings, a navigation system and many others.

The number of possible operator interventions and/or instructions from a vehicle driver which are necessary to control a vehicle continue to increase. In addition to the functions necessary for driving a vehicle, such as controlling the direction and speed of the vehicle there are more and more options for controlling additional functions. Such additional functions relate, for example, to vehicle systems, such as an air conditioning system, a sound system, a navigation system, settings of possible chassis functions and/or transmission functions and others.

The plurality of switches, knobs, keys, input displays and other operating elements available to a vehicle driver and the variety of information, indication and/or warning displays in the cockpit of a vehicle lead to an ever greater strain on the attention of the vehicle driver. At the same time, they increase the risk of the driver being distracted and thus increase the safety risk when driving a motor vehicle.

In order to reduce this safety risk many car manufacturers offer integrated electronic displays with a menu driven command control for vehicle systems, which combine a wide range of functions in a single user interface.

At the same time, a lot of information and choices for the driver must be displayed in the field of view of the driver or in a suitably placed display, greatly increasing the risk of the driver being distracted

Besides the representation of the information and choices, means for input or selection by the driver must be provided also in or near the display which can be operated by the driver while driving. These also pose a potential risk to the safety.

Since the operation of various vehicle systems requires a certain degree of a hand-eye coordination of the driver, the focus of the driver on the driving of the vehicle is at least partially impaired.

It is also known from the prior art to achieve a reduction in the information to be displayed in that only the information or choices in a specific context are displayed. These so-called context-sensitive information or choices are, for example, limited to a single vehicle system, such as a navigation system.

It is also known from the prior art to project information in the field of view of a user, for example, a vehicle driver, such as a car driver or a pilot, by means of a head-up display. A head-up display, abbreviated as HUD, is a display system in which the user can substantially maintain the position of the head or the viewing direction in the original orientation in order to view the displayed information. Such head-up displays generally have their own image generating unit, which provides the information to be represented in the form of an image, an optics module which enables the beam path within the head-up display to an outlet opening and is also referred to as mirror optics, and a projection surface for representing the image to be generated. The optics module directs the image onto the projection surface, which is formed as reflecting, translucent disk and is also referred to as a combiner. In a special case, a windshield suitable for this purpose is utilized as a projection surface. The vehicle driver sees the reflected information of the image generating unit and at the same time the real environment behind the windshield. In this way the attention of a vehicle driver, for example when driving a vehicle, continues to be directed at the events in front of the vehicle, while said driver can collect the information that is projected into the field of view.

A display device with at least one first concave mirror and one second concave mirror, the second concave mirror having at least one opening, is known from DE 10 2013 011 253 A1. Furthermore, the display device comprises a convex cavity formed by the two concave mirrors, a diffractive optical element arranged in the cavity, with a number of optical phase modulation cells, wherein the diffractive optical element provides an image and at least one light source for illuminating the phase modulation cells of the diffractive optical element, wherein the diffractive optical element is arranged in the cavity in such a way that radiation emanating from the at least one light source is modulated by the phase modulation cells, exits through the opening in the second concave mirror and depicts an image above the opening within a defined visual range.

According to one aspect of the publication, there is provided a vehicle having a display device according to one of the described exemplary embodiments, in which the display device can, in particular, be installed in the area of a dashboard, a center console or a steering wheel. The display device can be used not only as a display, but also as an output device and/or input device.

Moreover, it is disclosed that the holographic image reflects at least one actuating element of the vehicle, in particular, a switching element and/or a touchscreen. The vehicle also has at least one sensor for the detection of an input by a user in the visual range of the image, an evaluation unit for evaluating the input and an actuation unit for actuating a vehicle component depending on the input by the user.

DE 10 2005 010 843 A1 describes a head-up display in a motor vehicle wherein information, as pictorial messages, is brought into the field of view of the driver by means of the windshield wherein the pictorial message is stored in an icon strip as recallable icon by an action of driver. The head-up display described can have a separate display, which can represent a hologram.

In one embodiment, the head-up display has a detection device for detecting the haptic movement of the driver, which can carry out an infrared detection.

A system for generating at least one Augmented Reality help instruction for an object, in particular a vehicle, is known from DE 10 2004 044 718 A1. The system comprises a central control unit, an image reproducing unit connected to the central control unit, a 3D database operatively connected to the system, which has a plurality of 3D data sets, the 3D data sets representing together a model in three dimensions of at least a portion of the object. The central control unit is configured to generate a 2D image signal from at least one 3D data set, wherein the 2D image signal represents a two-dimensional image of at least a portion of the object from a predetermined viewing angle, and to send the 2D image signal to the image reproduction unit.

The system has a user interface which is configured to generate a user interaction signal as a function of a user action. The central control unit is configured to generate at least one, in particular graphical or acoustic, help instruction signal as a function of the user interaction signal, the help instruction signal representing a help instruction and a spatial location, wherein the spatial location is related to the model in three dimensions.

A user interaction signal can be generated, for example, by an eye movement sensor, a joystick, a trackball, a touch-sensitive surface or by a voice input unit, which can each be implemented independently of one another in one system.

The systems known from the prior art require at least one display or one head-up display for representing the information. Thus, the attention of the driver, with the exception of the representation of information in a head-up display, is at least temporarily directed to a specific area in the vehicle, thereby reducing the perception of the traffic situation by the driver.

### SUMMARY

The object of the invention is therefore to provide a user interface with a three-dimensional operating element and a method for inputting and outputting information in a vehicle, by means of which a simplified operation of vehicle systems and an improvement of the focus of the driver on the driving of the vehicle can be achieved.

The object is achieved by a subject matter with the features of claim 1 of the independent claims. Further developments are set forth in the dependent claims 2 to 6.

The invention provides a user interface (HMI) which projects for the driver of a vehicle, depending on the situation, three-dimensional operating elements into his field of view in the interior of the vehicle, for example in the vicinity of the steering wheel. By means of these three-dimensional operating elements, the driver can control vehicle systems or functions of the vehicle systems. The three-dimensional operating elements are generated by means of a holographic projection.

The vehicle systems to be controlled can be, for example, an air conditioning system, a sound system, a navigation system, a control system for a transmission, means for setting possible chassis functions and/or transmission functions and some others more.

The invention enables the driver to control a vehicle system, such as an air conditioning system, and in particular a function of this vehicle system, such as the interior temperature of the vehicle, by an interaction with a three-dimensional holographic operating element. There is no limitation to the vehicle systems or functions given by way of example.

Since such a holographic projection of a three-dimensional operating element takes place without a display or any other means for representing an image, the three-dimensional operating element can be projected at any desired location in the interior of a motor vehicle, preferably in the visual range of the driver. In addition, a representation of information on the three-dimensional operating elements or beside them is also possible.

This will allow to represent, for example, associated or possible information about current situations, and three-dimensional operating elements in his viewing direction by means of a suitable projection, for the driver. Preferably, this can take place by means of a laser projection which is suitable for both the representation of geometric shapes and characters such as letters. Such a projection can also take place in different colors.

The user interface according to the invention is designed in such a way that an operating action of the driver, for example, a selection of one of the represented choices of the three-dimensional operating element, is recognized by a suitable means for recognizing a movement or gesture of the driver and is provided to a corresponding central control and evaluation unit in the form of information.

This central control and evaluation unit, which is connected both to an image generating unit for the projection of a three-dimensional operating element and a means for the recognition of gestures of the driver, implements the provided information and effects a reaction associated with the selection of the driver, for example, switching on or off the corresponding function of a vehicle system. For such a gesture recognition, it is possible to utilize known means such as a camera which is attached inside the vehicle, and a corresponding evaluation unit

For generating a laser projection of the three-dimensional operating element, a spatial light modulator (SLM) can be formed. For example, technologies such as Liquid Crystal on Silicon (LcoS), Digital Light Processing (DLP) or Micro-Electro-Mechanical Systems MEMS can be utilized for image generation. It is particularly advantageous to generate three-dimensional projections or virtual images in a color representation.

The object is also achieved by a method having the features according to claim 7 of the independent claims. Further developments are set forth in the dependent claims 8 to 12.

The invention realizes a representation of holographic three-dimensional operating elements for a user interface for controlling various vehicle systems and their sub-functions in a vehicle, for example, a motor vehicle. For this purpose, it is provided to project such three-dimensional operating element in the driver's visual range. An area in the vicinity of the steering wheel of the motor vehicle can preferably be chosen as the area, with no limitation to this area.

The holographic three-dimensional operating element appears floating to the driver in the selected area wherein this virtual image can be a representation in one or more colors and different shapes. Forms provided for the three-dimensional operating element are forms such as, for example, a cube, a sphere, a cuboid, a pyramid, a tetrahedron or a cylinder having a round, elliptical or n-gonal base and top surface.

When the driver moves his hand or finger in the direction of the holographic three-dimensional operating element or on the holographic three-dimensional operating element, the gesture is detected. The gesture recognition is so precise that not only a coincidence of the position of a finger with the three-dimensional operating element is detected, but the exact position of the finger inside the three-dimensional operating element or on the three-dimensional operating element. The three-dimensional operating element can have multiple components which are associated with various selectable actions for controlling one or more vehicle systems. Such components can be, for example, the sides of an operating element which is represented as a cube. Each side can be associated with a separate function.

Alternatively, for example, on a side of such a cube-like operating element, multiple components can be displayed. For example, the components “Volume up” or “+” and “Volume down” or “−” can be displayed to control a sound system. The driver can then select one of the two options offered, i.e., the function for increasing the volume of the sound system, by a suitable gesture, wherein he, for example, places his finger on the position of the component “Volume up”. By recognizing this gesture, controlled by the central control and evaluation unit, a control signal is generated and transmitted to the sound system resulting in an increase in volume.

The components can also be projected in the form of a key which then is selected by the gesture of a finger touching the key. Since the central control and evaluation unit has information on the represented three-dimensional operating element and its areas and information on the gestures made by the driver, the central control and evaluation unit is capable of generating a corresponding control signal for the control of one or more vehicle systems or their sub-functionalities.

Controlled by means of this control signal, the selected function, for example the switching on or switching off a sound system or a change of the volume of the sound system can be implemented.

The three-dimensional operating element can have components such as text characters, special characters, symbols and plane or spatial geometric figures in different colors or images in one or more areas on its surface.

The three-dimensional operating element shows information in one or more areas on its surface, for example, in the form of text characters or symbols, which depict the possible functions which the driver can select. Advantageously, so-called context-related information can be represented.

In the case of such context-related information, a plausibility check is carried out before it is displayed in or on the three-dimensional operating element. In doing so, for example, an option for switching on the system is not offered in the selection if the system already is switched on. If, for example, a CD is played in a sound system, only the corresponding functions for operating the CD player and no choices for the selection of stations are displayed. For the recognition of the gestures of the driver, for example, with a hand or a finger of his hand it is particularly advantageous to utilize techniques in which a run-time measurement is carried out by means of a time-of-flight (ToF) camera. This gesture recognition offers a very high accuracy and is robust against disturbances, such as changing light conditions or sunlight. Alternatively, a method which uses infrared light can also be utilized.

It is advantageous to realize an eye tracking of the driver, that is, a recognition of the driver's viewing direction, by a means for gaze detection and eye tracking, such as a camera installed in the vehicle and an associated control and evaluation unit. An area inside or outside the vehicle on which the driver's gaze is directed, is recognized by the evaluation of this eye tracking. This information on the viewing direction of the driver can be used to control the generation of the three-dimensional operating elements. For example, an operating element is projected only in the event that the driver turns his gaze into a certain direction. Thus, a three-dimensional operating element for switching on or off the air conditioning system, for example, can be projected above an air outlet in the central area of the dashboard only in the event that the driver looks at the air outlet.

The user interface according to the invention with an image generating unit for representing images and information and a means for detecting an input, and the method according to the invention for inputting and outputting information in a vehicle have the advantage that the interaction between the vehicle and the vehicle driver takes place as an intuitive operation, wherein the virtual three-dimensional operating element being represented at the place where the operation takes place as an interaction and process while the eyes of the vehicle driver are directed on the road and the hands remain on the steering wheel, that is, without taking the hands off the steering wheel. Thus, the vehicle driver is not distracted during the process of operation, promoting a high attention to road traffic and the surroundings of the vehicle.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

Further details, features and advantages of embodiments of the invention will be apparent from the following description of exemplary embodiments with reference to the accompanying drawings.

FIG. 1 shows a schematic diagram of a user interface according to the invention,

FIGS. 2a, 2b show in each case a representation of an alternative option for positioning elements of the user interface according to FIG. 1,

FIGS. 3a, 3b show in each case a representation of an alternative image generating unit for generating virtual three-dimensional operating elements,

FIG. 4 shows a representation of an exemplary application of the invention with three-dimensional operating elements in case of an incoming call,

FIG. 5 shows a representation of a further exemplary application of the invention with a three-dimensional operating element in controlling a volume of a sound system, and

FIG. 6 shows a representation of a user interface according to the invention with a three-dimensional operating element for controlling various vehicle systems.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

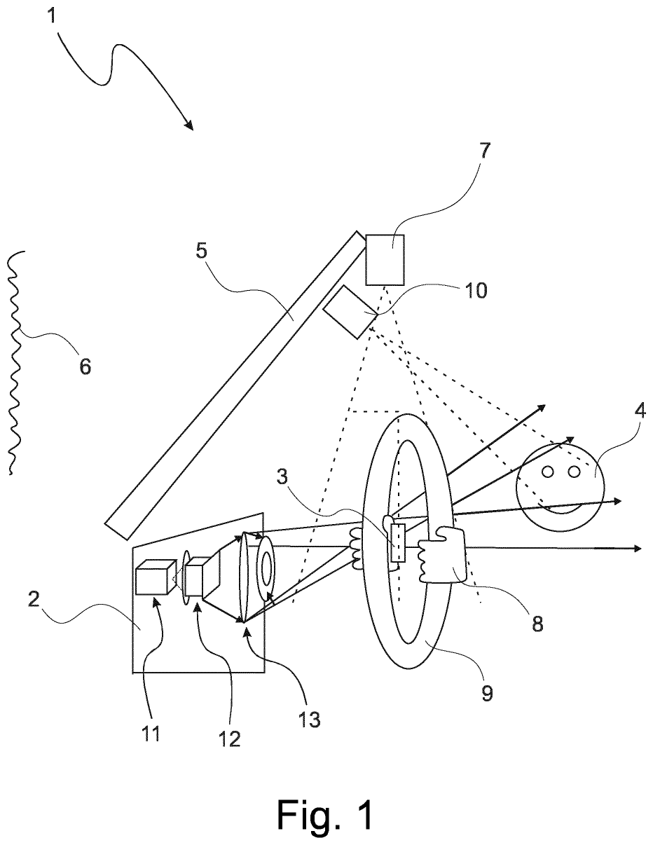

FIG. 1 depicts a schematic diagram of a user interface 1 according to the invention. An image generating unit 2 for generating a three-dimensional virtual operating element 3 projects a representation of a, for example, cube-like three-dimensional virtual operating element 3, into the visual range of a driver 4. This projection is carried out in the interior of the vehicle. In the example of FIG. 1, the three-dimensional virtual operating element 3, which hereinafter is referred to in short as operating element 3, is generated in a zone in front of the driver 4 in the area of the steering wheel 9, that is in an area between the represented hands 8 of the driver 4, and is therefore shown in FIG. 1 in a slightly obscured manner.

While driving the vehicle, the driver 4 can, in his viewing direction, which, for example, is directed substantially forwardly in the direction of travel of the vehicle, perceive both his environment 6 in front of his vehicle through the windshield 5, and at the same time the operating element 3 projected in his visual range. In FIG. 1, the environment 6 is only shown symbolically by a wavy line, but comprises for example roads, paths, vegetation, buildings, people, traffic signs and more.

For the implementation of the method according to the invention, a means 7 for gesture recognition is arranged in the interior of the vehicle. This means 7 is preferably directed to an area in front of the driver 4 and configured to enable a determination that a movement of a hand 8 or finger of the driver 4 is a gesture. In this context, a gesture is a movement of body parts such as arms, hands or fingers, through which something specific is expressed such as a selection of an offered alternative.

By a directed movement of a finger of his hand 8 to the represented virtual operating element 3, the driver 4 can affect the recognition of a “touch” of the operating element 3, as a result of which a control signal characterizing the “touching” is generated. When the operating element 3 is represented, for example, as a switch-on key of a sound system, then a quasi touch of this operating element 3 with the finger of the driver 4 leads to the generation of a control signal which switches on the sound system. For this purpose, a control and evaluation unit (not shown) is arranged in the vehicle. This control and evaluation unit is connected to the image generating unit 2 and controls the representation of the virtual operating element 3. The control and evaluation unit is also connected to the means 7 for gesture recognition and evaluates or processes the sensor signals of the means 7 for gesture recognition.

By connecting the control and evaluation unit to the image generating unit 2 and the means 7 for gesture recognition, it is possible to recognize or detect a quasi touch of the operating element 3 with a finger and to generate a corresponding control signal. This control signal is output and transmitted to the vehicle system to be controlled in order to control a function in this vehicle system. Such control can be switching on or off the vehicle system or a change in the volume, in the intensity of the lighting, a track change or station change and much more.

In order for the driver to be able to recognize which vehicle system or which function of a vehicle system is currently being offered for selection by the virtual three-dimensional operating element 3, it is provided, for example, to represent a symbol or an inscription on a surface of the operating element 3 which enables the driver 4 to recognize the association. Thus, a loudspeaker symbol in conjunction with a plus sign (+) can represent the option of increasing the volume of the sound system, while a loudspeaker symbol in conjunction with a minus sign (−) represents decreasing the volume.

In FIG. 1, a means 10 for gaze detection and eye tracking is optionally provided in an area above the windshield 5. This means 10 for gaze detection and eye tracking can, for example, be a camera and is directed at the driver 4. Thus, on the one hand, it can be determined whether the viewing direction of the driver 4 is directed to the outside through the windshield 5 or to an area within the vehicle, such as the dashboard. On the other hand, it can be recognized at which area of the dashboard or vehicle, the driver's 4 gaze is currently directed.

Thus, for example, an area of the openings for a ventilation system, an area for a display, an area for the control of gear functions or settings and an area of a flap over a glove compartment can be distinguished. To recognize the viewing direction the means 10 for gaze detection and eye tracking is connected to a central control and evaluation unit (not shown), which is controlled by means of a suitable software and has the necessary information relating to the corresponding vehicle equipment. Such information can be stored in a database by model by the vehicle manufacturer and are available for a suitable method for recognizing the viewing direction and the association of the vehicle areas within the vehicle.

This makes it possible to configure the projection of a virtual operating element 3 dependent on the viewing direction of the driver 4. While, for example, in the immediate visual range in front of the driver 4 in the vicinity of the steering wheel 9, the projection can be completely independent of the viewing direction of the driver 4, in other areas of the vehicle, such as an air outlet of an air conditioning system arranged in the center of the dashboard, a projection of the operating element 3 is carried out depending on the viewing direction of the driver 4.

Thus, in an exemplary case, an option for switching on or switching off the air conditioning system can be projected in a floating manner by a projection of a virtual operating element 3 in an area above the openings for the air outlet. In another case, a control option for the temperature and/or ventilation can be offered by a representation of another suitable operating element 3 above the same area.

In this case, also the driver can make a selection by a movement of his hand 8 or his finger, away from the steering wheel 9 towards the area of the virtual operating element 3, which corresponds to its desired function. For example, a virtual operating element 3 with the inscription “ON” could be provided to switch on the air conditioner.

This selection of the driver 4 is registered by the means 7 for gesture recognition and a corresponding control signal is generated by the central control and evaluation unit, by means of which the air conditioning system is controlled in such a way that it switches on.

In addition, it is provided to achieve a restriction of the choices offered on an operating element 3 in such a way that prior to the projection of the operating element 3 it is checked whether the choices are currently available in the current operating state of the vehicle or the corresponding system. If restrictions are present, the projection will be adapted accordingly, thus only plausible choices will be made available. For example, a function of an automatic speed control can be offered only above a minimum speed. An option to switch on a vehicle system can, for example, be offered only if the corresponding vehicle system is currently switched off. These context-related representation of choices leads to a reduction of the information which the driver 4 must perceive in addition to driving the vehicle.

Furthermore, a subdivision of a surface of a virtual operating element 3 into multiple areas on this surface is provided also. In each of these areas a choice can then be made available by a representation of a corresponding symbol or a corresponding text. In one example, an operating element 3 could be projected for the driver 4, which enables switching on or switching off multiple represented vehicle systems or functions. In another example, an operating element 3 could be projected for the driver 4 which provides both a change in volume as well as a sound setting for a sound system.

The image generating unit 2 represented in FIG. 1 can, for example, have a laser module 11, a phase arrangement 12 (phase SLM device) for generation of a hologram and a lens 13.

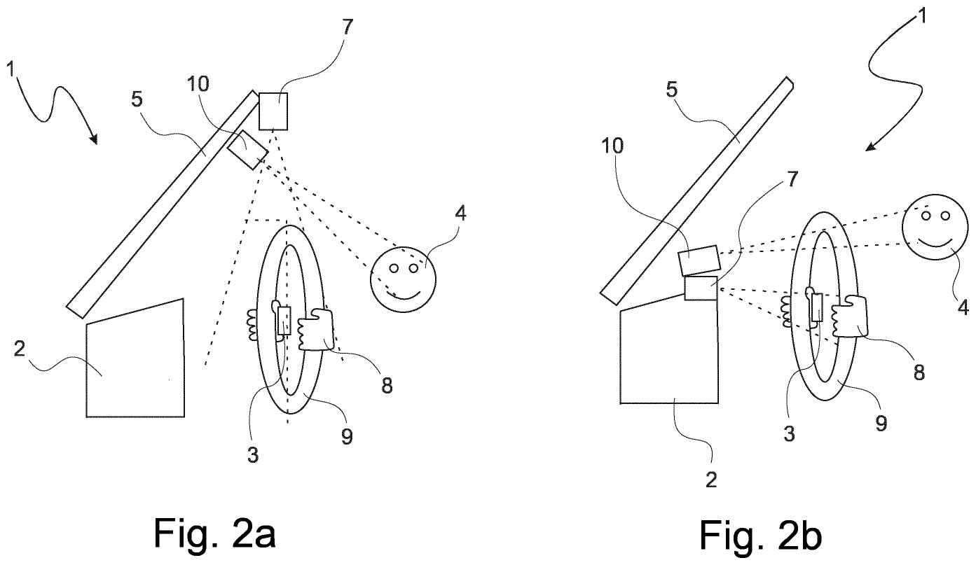

FIGS. 2a and 2b each represent an alternative option for positioning elements of the user interface according to FIG. 1. A user interface with an image generating unit 2 is shown in each alternative. In addition, the virtual operating elements 3 generated by the image generating unit 2 are represented. In addition, a driver 4 with his hands 8 on the steering wheel 9 and a windshield 5 of a vehicle are shown in each case.

FIG. 2a shows a variant, in which the means 10 for gaze detection and eye tracking is arranged in the upper area of the windshield 5 and has an orientation at an angle of about 45 degrees to the driver 4. In this representation the means 7 for gesture recognition also arranged in the upper area of the windshield 5. The means 7 for gesture recognition can be a 3D camera, which is realizing a three-dimensional image recording. The means 7 can also be configured as a so-called ToF (Time of flight) camera, which realizes a measurement of distances by means of a run-time method. Alternatively, a system consisting of a 2D camera for recording two-dimensional images and a 3D camera can be utilized. Also, the utilization of a camera operating in the infrared range can be provided. The means 7 for gesture recognition is directed approximately perpendicular to the area in front of the driver 4.

FIG. 2b shows a variant, in which the means 10 for gaze detection and eye tracking is arranged in the area in front of the driver 4 and is directed almost horizontally or slightly upwards at the driver 4. In this representation, the means 7 for gesture recognition also is arranged in the area in front of the driver 4 and directed towards the latter, at the area of the steering wheel 9.

A ToF camera, which is connected to a corresponding central control and evaluation unit, for example, can be used as a means 7 for gesture recognition.

The alternatives represented in FIGS. 2a and 2b are only two exemplary embodiments and do not limit the arrangement according to the invention to these represented options. Further alternatives in which both a gaze recognition and a gesture recognition are ensured are conceivable.

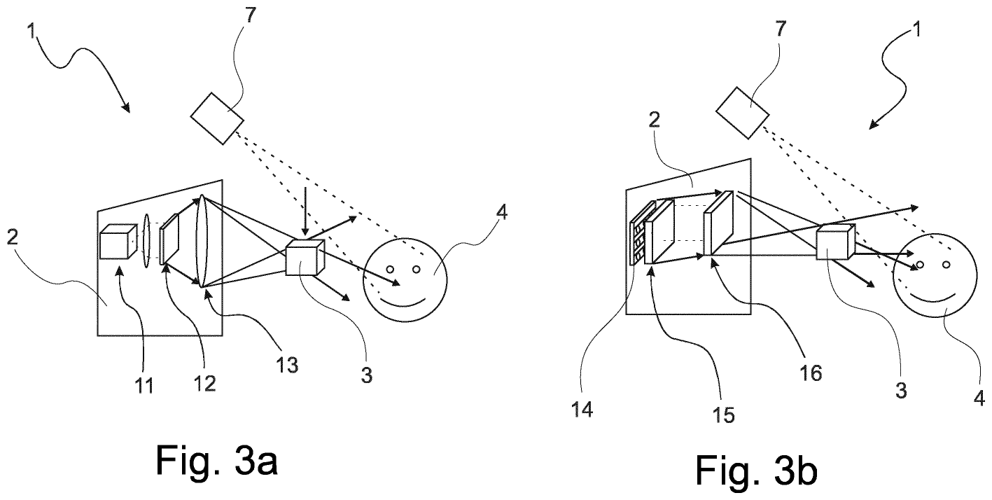

FIGS. 3a and 3b each represent an alternative image generating unit 2 for generating virtual operating elements 3. While in FIG. 3a a unit consisting of a laser module 11, a phase arrangement 12 as a so-called SLM unit (spatial light modulator/LcoS, LC, AOM) for generating a hologram and a lens 13 is utilized for generating the virtual operating element 3, the image generating unit 2 of FIG. 3b has a unit with a laser background illumination 14 or in a MEMS (micro-electro-mechanical-system) technology, in which varicolored laser beams which are deflected by a mirror system cause a generation of an image, a nanostructure unit 15 (nanostructured static hologram/engineered micro-pixel) and a diffuser unit 16. There is no limitation of the invention to these options of image generation, thus, only exemplary embodiments are shown.

The laser module 11 advantageously includes a coherent light source such as an RGB laser or a monochrome laser source. The phase arrangement 12 for spatial light modulation (SLM) can be implemented as an LC device, LCoS device, DLP device, an AOM or EOM.

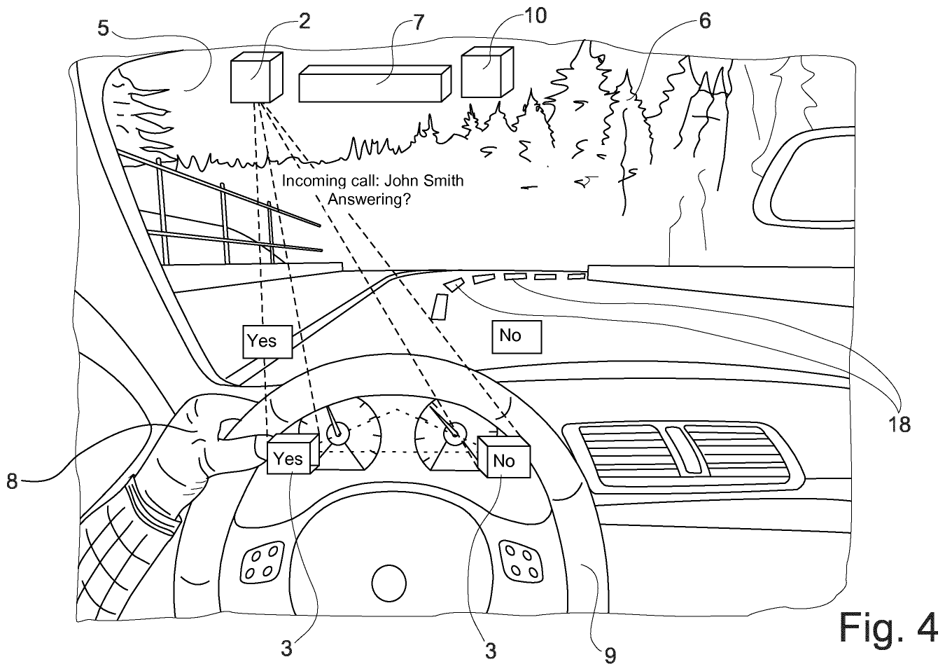

In FIG. 4, a further exemplary application of the invention is shown in the case of an incoming call. In this example, a mobile telephone of the driver is connected to the central control and evaluation unit in the vehicle. Such connection may be effected utilizing a data transmission according to the USB or Bluetooth technologies and is intended to enable the driver, to control the telephone by input means present in the vehicle. In addition, it is common that a sound system present in the vehicle is used for the acoustic reproduction and recording or input of the voice of the driver 4.

The example in FIG. 4 shows a representation generated by means of a HUD unit in the area of the windshield 5. An information regarding an incoming call is displayed with the exemplary inscription “Eingehender Anruf” or “Incoming call” and a choice “Annehmen” or “Accept?” to answer or reject the call. In addition, the name of the caller, in this case “John Smith”, can also be displayed.

This output generated by the HUD unit is merely an additional pictorial representation which is not necessary for the method according to the invention. There is no input option or choice for the driver 4.

An input option or choice is provided by the proposed method and the associated arrangement. For this purpose, two virtual operating elements 3 in the form of two cubes or cuboids are represented in an area in front of the steering wheel 9 by the image generating unit 2. This representation is preferably carried out in a three-dimensional representation of the operating elements 3 in such a way that the first operating element 3 is provided with the inscription “Yes” or “Ja”, and the second operating element 3 with the inscription “No” or “Nein” in one of its areas, such as a side. In an alternative the areas of the operating elements 3 also can be provided with the signs or symbols “Tick” [symbol] for the answering the call and “Cross” (X) for declining. Thus, a selection to answer the telephone call by means of the left first operating element 3 and for declining the telephone call by means of the second operating element 3 shown on the right is provided to the driver 4.

The means 7 for gesture recognition is used to recognize the selection the driver 4 is making between the two operating elements 3, and depending on this recognized selection by means of the central control and evaluation unit, the incoming call is answered or declined. After recognizing a selection made, the generation of the three-dimensional operating elements 3, that is the representation of the two cubes or cuboids, is terminated. The generation of the graphical representation by the HUD unit is also terminated. An exemplary additional representation of the route 18 by the HUD unit is maintained while performing the method according to the invention for inputting and outputting information in a vehicle.

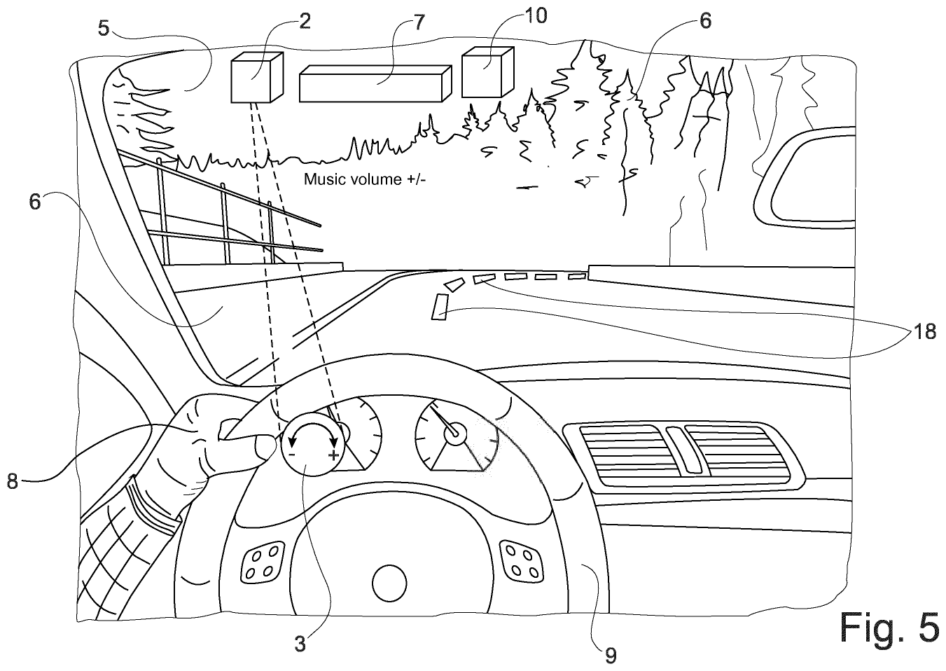

FIG. 5 shows a further exemplary application of the invention in controlling a volume of a sound system arranged in the vehicle.

In contrast to FIG. 4, optionally an inscription with the text “Music Volume +/−” or “Musik Lautstärke +/−” is displayed in addition to a representation of the further route 18 by the HUD unit. The image generating unit 2 generates a virtual operating element 3 in the form of a three-dimensional wheel, which is provided, for example, with a double arrow and the sign “+”, for an increase in volume of the sound system, and the sign “−” for a decrease in volume.

A projection of this choice for changing the volume can take place, for example, if a viewing direction of the driver 4 to an area with a volume control of a sound system is recognized by the means 10 for gaze detection and eye tracking. Alternatively, the projection can take place as a result of a recognized voice command or a prior selection on a previously projected operating element 3.

The representation of the virtual operating element 3 takes place again in an area in front of the steering wheel 9 and can be reached very easily by the driver 4. The driver 4 can make a selection, for example, in such a way that he “touches” the virtual operating element 3 on its right half to increase the volume. An increase in volume can, for example, take place by a fixed amount in case of a coincidence recognized using the means 7 for gesture recognition. Alternatively, the volume can be increased for as long as a coincidence between the right half of the operating element 3 and the hand 8 or a finger of the driver 4 is recognized.

In the event that a coincidence between the left half of the operating element 3 and the hand 8 is recognized, a decrease in volume by a fixed amount takes place or as long as the coincidence is recognized.

In a particular embodiment, it is provided that the represented virtual operating element 3 is configured to be rotatable like a knob-shaped volume controller and, depending on the direction of rotation, a decrease or increase in volume is performed. Such a rotary movement can be triggered by the driver 4 by stroking along an edge of the wheel and turning it into a rotary movement.

After setting the volume and a lapse of a fixed waiting time, the projection of the virtual operating element 3 configured as a rotary knob and the representation of the inscription by the HUD-Unit are terminated. In this example too, an additional representation of the route 18 is not affected by the HUD unit.

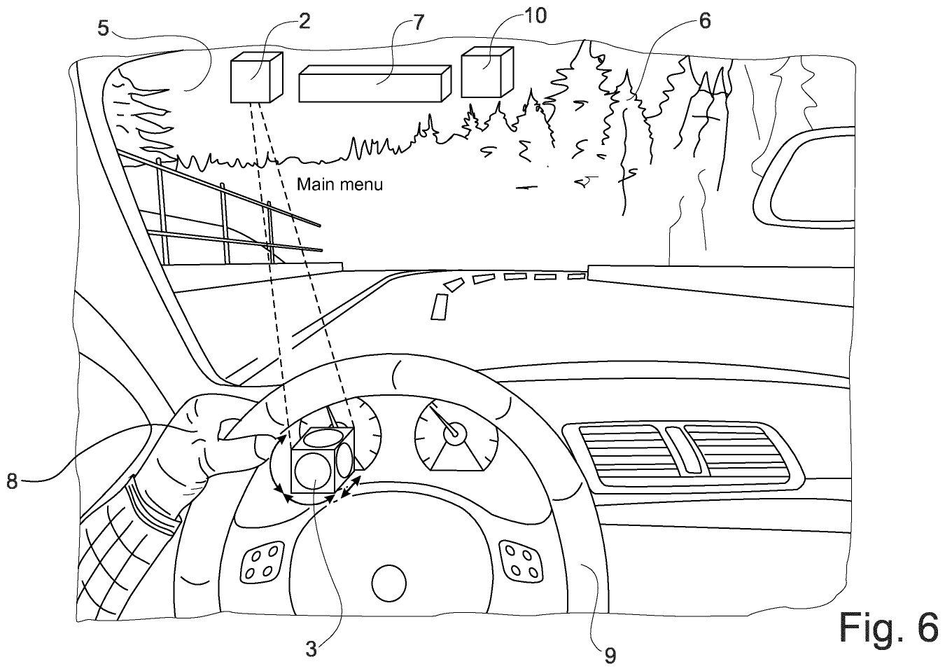

As shown in FIG. 6, the virtual operating element 3 can also be represented in the form of a three-dimensional cube, which displays setting options or choices on its sides. For example, the sides or areas of the operating element 3 could depict functions of different vehicle systems or functions of one vehicle system, such as a sound system. In the case of a sound system, for example, choices for volume, radio stations, sound sources, sound settings and similar are represented on the sides of the projected cube. The driver 4 can rotate the virtual cube-like operating element 3 about one or more axes and in doing so bring the desired function to the front of the cube and select by “Tapping”. When the driver 4 has selected, for example, volume setting, the virtual operating element 3 in the form of a small wheel for volume setting, described already above with respect to FIG. 5, is represented. In addition, an inscription with respect to the current front of the operating element 3, such as for example with the inscription “Hauptmenü” or “Main menu” is possible by the HUD.

### LIST OF REFERENCE NUMERALS

1 User interface
2 Image generating unit, laser projection unit
3 Three-dimensional virtual operating element
4 Driver
5 Windshield
6 Environment
7 Means for gesture recognition
   8 Hand
   9 Steering wheel
   10 Means for gaze detection and eye tracking
   11 Laser module
   12 Phase arrangement
   13 Lens
   14 Laser background lighting/MEMS
   15 Nanostructure unit
   16 Diffuser unit
   17 Activating the selected function
   18 Route

The detailed description and the drawings or figures are supportive and descriptive of the disclosure, but the scope of the disclosure is defined solely by the claims. While other embodiments for carrying out the claimed teachings have been described in detail, various alternative designs and embodiments exist for practicing the disclosure defined in the appended claims.

1. A user interface comprising an image generating unit for the representation of images and information, and a means for detection of an input, wherein the arrangement and the means are connected to a central control and evaluation unit, characterized in that a laser projection unit generating at least one virtual three-dimensional operating element as the image generating unit and a means for gesture recognition as a means for detection of an input are arranged in the interior of a vehicle.

2. The user interface according to claim 1, characterized in that the virtual three-dimensional operating element has the form of a cube, a cuboid, a sphere, a pyramid or a cylinder having a round, oval or n-gonal base and top surface.

3. The user interface according to claim 1, characterized in that the virtual three-dimensional operating element has multiple areas, an area being arranged on a surface or part of a surface

4. The user interface according to claim 1, characterized in that a means for gaze detection and eye tracking is arranged in the interior of a vehicle.

5. The user interface according to claim 1, characterized in that the means for gesture recognition and/or the means for gaze detection and eye tracking is a 3D camera or a time-of-flight (ToF) camera.

6. The user interface according to claim 1, characterized in that a heads-up display (HUD) unit is arranged as a further means for displaying information in the vehicle.

7. A method for inputting and outputting information in a vehicle in which information is output by means of an arrangement for image generation and in which inputs of a driver are detected by means for detecting an input, a control of the output of the information and the detection of inputs being controlled by a central control unit, characterized in that at least one virtual three-dimensional operating element is projected in the visual range of a driver and in the interior of a vehicle by means of a laser projection arrangement in such a way that a gesture of the driver is detected by a gesture recognition means, and in that, when a position of a hand of the driver detected by means of the gesture recognition and the virtual operating element or an area of the virtual operating element are coinciding, a signal for controlling a vehicle system or a function of a vehicle system is generated by the central control and evaluation unit and is output to the corresponding vehicle system.

8. The method according to claim 7, characterized in that the virtual operating element is projected with multiple areas, the areas being surfaces of the three-dimensional operating element or sections of an area of the three-dimensional operating element.

9. The method according to claim 8, characterized in that in the areas or sections information is represented in the form of text characters, special characters, symbols, plane or spatial geometric figures in different colors or images.

10. The method according to claim 7, characterized in that the information represented in the areas or sections is contextual information and/or plausibility-checked information.

11. The method according to claim 7, characterized in that a detection of the viewing direction of the driver takes place by means of a means for gaze detection and eye tracking.

12. The method according to claim 7, characterized in that the gesture recognition is carried out by means of a run-time method or an infrared method.
